(19) United States
(12) Patent Application Publication
(10) Pub. No.: US 2002/0149123 A1
(43) Pub. Date: Oct. 17, 2002

(54) Apparatus for the detachable securement of aeration devices in water aerating units

(76) Inventors: Volker Edel, Isernhagen (DE); Franz-Ferdinand Bruse, Wedemark (DE)

Correspondence Address: ROBERT W. BECKER & ASSOCIATES, 707 HIGHWAY 66 EAST, SUITE B, TIJERAS, NM, 87059, US

(21) Appl. No.: 09/887,858

(22) Filed: Jun. 22, 2001

(30) Foreign Application Priority Data
Jun. 23, 2000 (DE) 100 29 689.0

(51) Int. Cl. B01F 3/04

(52) U.S. Cl. 261/122.1; 210/220

(57) ABSTRACT

An apparatus for the detachable securement of aeration devices to air supply lines of units for aerating water with fine bubbles is provided. The fastening elements that are intended to surround the air supply line comprise two flexible securing elements, one end of which is anchored to the aeration device, or to the holder thereof, while the free ends are adapted to be hooked together. At least one insert is inserted, under tension, between hooked together securing elements on the one hand, and the air supply line on the other hand.

### BACKGROUND OF THE INVENTION

The present invention relates to an apparatus for the detachable securement of aeration devices to air supply lines of units for aerating water with fine bubbles, whereby the fastening elements surround the air supply lines.

Apparatus of this general type are known where the fastening devices are formed of two half shells or a split collar. Since the collar or half shells have a rigid construction, they must be precisely adapted to the outer contours or diameter of the air supply line. Tolerances or variations in dimensions cannot be compensated for by such devices.

It is therefore an object of the present invention to improve apparatus of the aforementioned general type in such a way that now tolerances can in fact be compensated for. At the same time, it is another object of the present invention to provide a particularly reliable securement in order to be able to secure aeration tubes, for example tubes that are many meters in length.

### BRIEF DESCRIPTION OF THE DRAWING

These and other objects and advantages of the present invention will appear more clearly from the following specification in conjunction with the accompanying schematic drawing, in which:

FIG. 1 is a cross-sectional view through an air supply line and one exemplary embodiment of the inventive apparatus for the detachable securement of a tubular aeration device to the air supply line;

FIG. 2 is a side view of the apparatus of FIG. 1 taken in the direction of the arrow 11 thereof; and

FIG. 3 is a partial cross-sectional view through the apparatus of FIG. 1 taken along the line III-III thereof.

### SUMMARY OF THE INVENTION

The apparatus of the present invention is characterized primarily in that the fastening elements are formed of two flexible securing elements, one end of each of which is anchored to the aeration device, or to the holder thereof, while the free ends of the securing elements are adapted to be hooked together; after the securing elements are hooked together, a preferably conical or wedged shaped insert is inserted between the securing elements and the air supply line to hold the securing elements undertension. In this connection, an insert (separator) can be associated with each securing element; however, preferably only a single insert is provided in the region of the hooking location between the securing element ends.

Pursuant to the present invention, the fastening of the securing elements is first undertaken, and only then is the conical or wedge shaped insert introduced, expediently by being forced or driven in, in order in this manner to compensate for any variations or imprecisions of the dimensions, and to achieve the tensioning of the securing elements that is required for a reliable securement.

The two securing elements on the one hand, and the holder means for the aeration device on the other hand, are preferably monolithically produced as a molded article made of polymeric material, wherein a hard or tough polymeric material is used, for example on a polypropylene base.

The aeration device can have any desired configuration. However, plate shaped aerators, as well as tubular devices that are provided with a slitted surface, are preferably used, and as a consequence of the inventive apparatus can have a length of several meters.

Further specific features of the present invention will be described in detail subsequently.

### DESCRIPTION OF PREFERRED EMBODIMENTS

The apparatus that is to be described subsequently is a component of a unit that is disposed in the water for aerating bodies of water and water reservoirs or tanks with fine bubbles.

The slightly compressed air is supplied via a conduit or tube 1 (air supply line), from which the individual aeration devices, a plurality of which are generally provided, and which are in the form, for example, of an aerating tube 2, are supplied directly, or indirectly via a further tube.

An approximately tubular holding means 4, for receiving the aerating tube 2, has an upwardly directed connector 5 that projects into a hole of the conduit 1. For sealing purposes, non-illustrated seals are disposed in a groove 7 of the holding means 4; in addition, a sealing sleeve can also be provided in the region of the connector.

From the conduit 1, the air passes via the connector 5 and via known formations or arrangements between the outer surface of the aerating tube 2 and a tube 7′ that is made of rubber or other elastomeric material and is provided with fine slits. Under the effect of the over pressure, the slits of the elastomeric tube 7′ open; the air then escapes into the water in the form of fine bubbles. The aerating tube 2 extends beyond the holding means 4 on both sides, and extends at right angles to the conduit 1. It is to be understood that the aerating tube 2 could also extend from only one side of the holding means 4.

In order to adequately reliably secure the holding means 4 on the conduit 1, a relatively thin-walled secured element 8 is secured to each side of the holding means 4. Each securing element 8 merges monolithically with the body of the holding means 4, and due to its thinness is bendable or flexible. The holding means 4 and the securing elements 8 are a molded article of hard polypropylene.

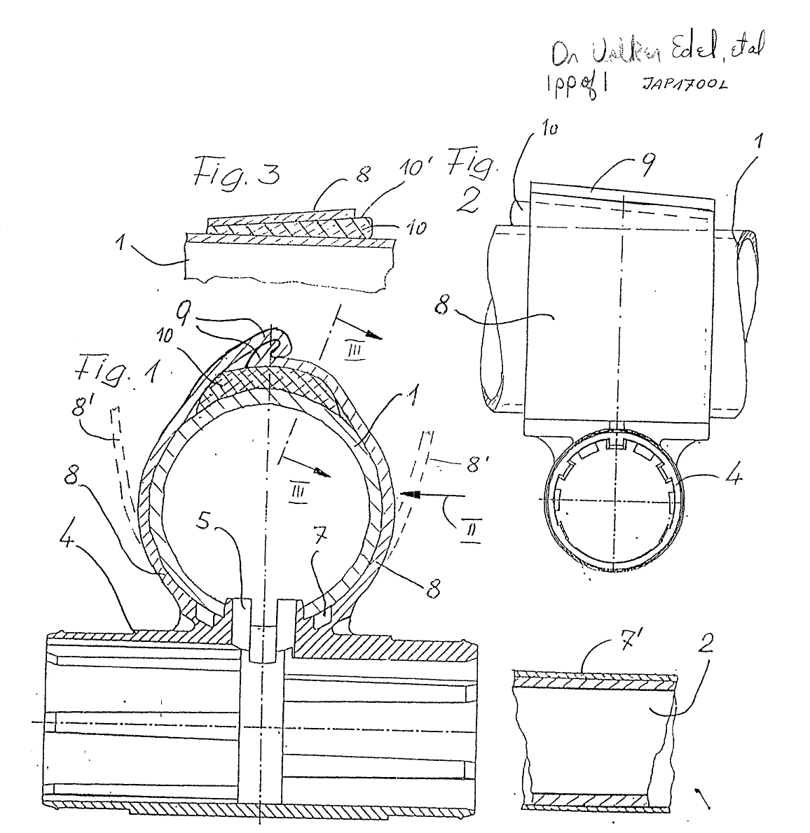

The free ends of both of the securing elements 8 are provided with hooks or similar clasping means 9 in order to be able to positively interconnect the securing elements or to hook them together in the operative position. As can be seen in FIG. 1, this hooking together takes place at a location of the conduit 1 that is opposite from the holding means 4. Also disposed at this location is an insert 10, which in particular is disposed between the ends of the securing elements 8 on the one hand and the conduit 1 on the other hand. When viewed in cross-section, the insert 10 has a curved shape in conformity with that of the conduit 1; however, as can be seen from FIG. 3, when viewed in longitudinal section the insert 10 has a wedge shape. As can furthermore be seen from FIGS. 2 and 3, the ends of the securing elements 8 also have a shape corresponding to the wedge shape; these ends of the securing elements rest against the inclined outer surface 10′ of the insert 10.

It should be noted that for manufacturing and assembly reasons, when the securing elements 8 are not yet hooked together, i.e. are in the position of rest, they both extend upwardly at an angle in a V-shaped manner as indicated by the dashed lines 8′ in FIG. 1.

To mount or assemble the holding means 4 on the conduit 1, the ends of the securing elements 8 are first looped around the conduit 1 and are hooked together. The insert 10 is then driven or forced in, whereby the securing elements 8 are stretched and are finally left under tension, thereby securing the fastening and compensating for possible variations in dimension. To release the securement, the thinner end of the insert 10 has force applied to it, possibly with a tool, thereby freeing the insert 10.

It is to be understood that the wedge angle is selected in such a way that a self-locking occurs; in other words, an undesired release of the insert cannot occur.

It should also be noted that different length securing elements 8 could also be utilized, whereby, however, also in this situation an inclined position, as indicated by the reference numeral 8′, at an angle of about 30-60° to a vertical, can also be utilized in order to facilitate removal from a mold during the manufacturing process. If desired, a securing element 8 could also have a stub-like configuration.

As indicated, the inventive detachable connection can also be used with plate-shaped aeration devices or plate aerators. However, in such a situation the fastening device with the two securing elements 8 and the insert 10 is expediently disposed below the plate.

The specification incorporates by reference the disclosure of German priority document DE 100 29 689.0 of Jun. 23 2000.

The present invention is, of course, in no way restricted to the specific disclosure of the specification and drawing, but also encompasses any modifications within the scope of the appended claims.

What we claim is:

1. An apparatus for the detachable securement of aeration devices to air supply lines of units for aerating water with fine bubbles, said apparatus comprising:
fastening elements for surrounding an air supply line, wherein said fastening elements each comprise two flexible securing elements having a first end anchored to an aeration device, or to a holder thereof, and a second free end, wherein said free ends of said securing elements hook together; and
at least one insert for insertion, under tension, between hooked together securing elements on the one hand, and said air supply line on the other hand.

2. An apparatus according to claim 1, wherein said at least one insert has a conical or wedge shape.

3. An apparatus according to claim 1, wherein a single insert is provided essentially in the region of a connecting location of said two securing elements.

4. An apparatus according to claim 3, wherein said insert is disposed at a location of said air supply line that is opposite a location of a holder.

5. An apparatus according to claim 1, wherein at least an inner surface of said at least one insert is curved in conformity with an outer contour of said air supply line.

6. An apparatus according to claim 1, wherein at least one of said securing elements, in the vicinity of said at least one insert, has a shape at least on an inner side thereof that corresponds to an inclined surface of said insert.

7. An apparatus according to claim 1, wherein in a rest position of said securing elements, when said securing elements are not hooked together, the latter extend at an angle outwardly in a V-shape.

8. An apparatus according to claim 2, wherein said at least one insert provides a self-locking situation.

9. An apparatus according to claim 1, wherein said securing elements have different lengths.

10. An apparatus according to claim 9, wherein one of said securing elements is stub-shaped.

11. An apparatus according to claim 7, wherein said securing elements form an angle of about 30-60° relative to a vertical.
